(19) United States
(12) Patent Application Publication
(10) Pub. No.: US 2016/0279823 A1
(43) Pub. Date: Sep. 29, 2016

(54) MEANS AND METHOD FOR PREVENTING A TANNIN MIGRATION FROM WOOD

(71) Applicant: BK GIULINI GMBH, Ludwigshafen (DE)

(72) Inventors: Thomas Staffel, Gruenstadt (DE); Marina Fleischhauer, Bad Schoenborn (DE); Siegbert Weber, Ladenburg (DE)

(73) Assignee: BK Giulini GmbH, Ludwigshafen (DE)

(21) Appl. No.: 15/035,079

(22) PCT Filed: Nov. 8, 2013
(86) PCT No.: PCT/EP2013/003376

§ 371 Date: May 6, 2016

(51) Int. Cl. B27K 3/34; C09D 189/00; B27K 3/15

(52) U.S. Cl. CPC B27K 3/34; B27K 3/153; C09D 189/00

(57) ABSTRACT

The invention relates to the treatment of wood or wood products, in particular for preventing the leakage or migration of tannin from the wood. Said leakage can be effectively prevented by treating the wood with a gelatin solution and/or with a wood treating agent which contains gelatin and gelatin derivatives.

This invention relates to the treatment of wood or wood products, in particular to prevent the leakage of migration of a tannin from the wood. This leakage can be effectively prevented by treating the wood with a gelatin solution and/or with a wood treatment agent that includes gelatin and gelatin derivatives.

It is generally known that in processing or using wood and wood products, the tannins contained in the wood leak out, despite treatment with coating products and pigments, and become noticeable by disturbing stains, also known as staining or “bleeding-out” phenomenon.

Chemically seen, dealing with tannins relates to polyhydroxyphenols, which are soluble in water, ethanol, and in acetone as well. The plant tannins vary significantly in their chemical structure and biological activity. They are found in the wood bark of oaks, birches, and chestnut trees, in tropical high-grade woods, in the fruit husk of the walnut, in wine grapes, and in plant galls. Monomer groups of tannins are also contained in hops and in black and green tea.

Wood is used very frequently as a building material for houses, yards, and gardens.

It is subject to the effects of bad weather, direct contact with the earth or [sic] and is thereby destroyed by bacteria, fungi, or insects. That is why wood in general is treated in order to protect it over the long term from these destructive influences. In treating wood, recently greater importance has been laid on what are called less harmful products, particularly if treatment with the wood is necessary for interior spaces. In using wood as a construction material, for example as a wood floor or doors and windows, it is therefore often treated with water-soluble paints. A frequently occurring problem thereby is the bleeding out of water-soluble products in the wood, primarily the tannins from the wood, despite a surface coating with varnishes and paints. The leaking tannins create stains and discoloration spots, often ugly, but in any case not desired.

Especially frequently an increased discoloration in the area of what are called knot holes in the wood is seen because there the concentration of tannins is frequently higher.

However, the trend and the legislation on the grounds of environmental protection demand ever more water-based coatings as opposed to these solvents that contain other matter. Therefore it is principally the water-based coatings that are very widely used for wood.

The problem of what is called tannin migration has been solved in various ways in the state of the art:

In U.S. Pat. No. 4,104,228 and U.S. Pat. No. 4,075,394 the proposal was made to prevent tannin migration by using a wood paint that contains a linear, partially deacylated poly(N-acyl)alkylamine in the formula. This polymer can be applied beforehand directly on the wood or together with the wood paint product in the formulation on the wood.

In U.S. Pat. No. 6,485,786, a water-based tannin-blocking paint material or coating was proposed, consisting of an emulsion copolymer, which is polymerized out of ethylene unsaturated monomers.

Another method was revealed in U.S. Pat. No. 6,113,989. There non-acidic inorganic compounds were used, such as an ammonium, sodium, or potassium zirconium carbonate, which were worked into the polymer wood paint product. The wood was painted with this product, and after appropriate drying, a semi-permeable film, resistant to moisture, formed on the surface of the wood, which prevented the leakage of tannin from the wood.

In U.S. Pat. No. 6,533,856, aluminum and tin compounds were formulated in the wood coating material to prevent the tannin migration out of the wood.

In U.S. Pat. No. 6,245,141, organotitanium compounds were revealed, for example a neoalkoxy titanate, which were worked into the coating material as a tannin blocker. These titanium compounds preferentially have one or several functional amino groups.

In this respect U.S. Pat. No. 6,531,223 is also relevant, in which a coating without a primer, thus a first coat of paint, is proposed. This coating contains essentially two components, mainly a water-soluble latex emulsion and what are called the microspheres, which absorb little water. These include for example sodium or potassium aluminum silicate particles, glass balls, hollow glass balls, or even expanded acrylonitrile-vinylidene chloride copolymers, and others. It was essential here that the diameters of these particles should be if possible not greater than 210 μm.

In U.S. Pat. No. 5,529,811, zinc cyanamide was proposed as a tannin blocker, and U.S. Pat. No. 5,27,619 used latex copolymers containing organisilanes as an additive to prevent tannin migration.

Although in the state of the art the above mentioned proposals for solutions to prevent tannin migration have already been made, till now a solution has been lacking that makes use of a natural compound appearing in nature.

A simple and effective solution of the problem of tannin migration out of wood can surprisingly be found in the use of gelatin.

Gelatin is a mixture of polypeptides, obtained in mol weights of about 13,500 to 500,000 (determined by SDS gel electrophoresis or gel chromatography), obtained principally by a more or less widespread hydrolysis of the collagen contained in pork rind, in rind and calf cracklings, and in their bones. In commerce, gelatin is available as a granulate, as sheet gelatin, and as a solution. The amino acid composition corresponds extensively to that of collagen, from which it is obtained. It is odorless and practically colorless, not soluble in ethanol, ethers and ketones, soluble in ethylene glycol, glycerol, formamide, and acetic acid.

As part of this invention, essentially a gelatin is used that no longer exhibits the capacity to gel; it can be used as obtained from a gelatin powder dissolved in water.

Analogously to leather tanning, where tannin is used as a tanning material, principally to link with the collagens found in the skins, the inventors have determined that gelatins, as a collagen decomposition product, have successively been used in preventing tannin migration and have had very good results. In tanning, the tanning materials or the tannins, which are obtained from oak or spruce bark, mimosas, sumacs, and other types of wood, are used as bark tanning materials (“tan bark”). In this process, the collagen molecules are clearly linked and thus are permanently connected with the help of tanning materials, which essentially are tannin or which contain tannin.

In using gelatins as an additive in the corresponding wood coating materials, the tannin is converted into a non-soluble gelatin (collagen) tannin complex. A non-water-soluble, colorless deposit is formed. In this way, tannin is quasi-bound, and the stain buildup and the bleeding out are prevented.

Gelatins according to the invention can be painted on or sprayed on as a watery solution directly onto the wood surface. After this treatment, the wood can be handled again with any coating material—the desired blocking effect can be optimally obtained in this matter. It is essential here that the concentration of the aqueous gelatin solution should lie between 2 and 8%.

Such a solution can be easily created by dissolving a gelatin powder in cold or warm water.

Gelatin powers are obtainable commercially. In particular, the types most appropriate are from Gelita, e.g., collagen A, or Biogel, e.g., Vitagel PLPR. The weight of the gelatin that is applied per cm² of the wood surface is 5 to 10 mg/m² lying on the wood surface.

According to the invention, there are two basic possibilities of applying the gelatins or gelatin derivatives onto the wood surface.

1. One can apply the watery gelatin solution to the wood surface, for example through brushing or painting, and then rework the wood surface after drying with other standard wood painting materials.

2. One can work the gelatin powder or the gelatin solution into the standard wood coating materials, something that is possible without any problem because the gelatin does not have any negative effects that change the wood coating materials or its ingredients. In this manner of proceeding, however, the precondition is that the manufacturer of these wood coating materials work the gelatins directly into the formulations.

According to this invention, examples were worked out for both approaches in order to show the effect in preventing tannin migration.

### EXAMPLE 1

### Of a Separate Text

In this test, a 5% aqueous gelatin solution was made through dissolving gelatin powders (gelatins 2 and 3). Then a fluid food gelatin with 20% concentration was used (gelatin 1).

Gelatin 1=fluid food gelatin with 20% active ingredient

Gelatin 2=food gelatin in powder form with 100% active ingredient/drawn from Switzerland

Gelatin 3=food gelatin in powder form with 100% active ingredient/drawn from Germany

All the gelatin types are products that are obtainable in commercially.

The gelatin solutions were in each case thinly applied to an oak wood board (30×11 cm) with a brush and dried for 24 hours at room temperature. Here the entire amount applied was always 2 g.

After drying, a white wood lacquer with a layer 150 μm thick was applied. The boards were stored for one week at 25° C. and 50% relative humidity. Thereafter a measurement of the level of white was performed with a “Minolta CR 200” photometer.

TABLE 1
results for example 1:

| | | Gelatin 1 | Gelatin 2 | Gelatin 3 |
|---|---|---|---|---|
| Meanured values | Null sample | 5% | 5% | 5% |
| L | 93 | 95.3 | 95.5 | 95.4 |
| b+ | 5.8 | 4.8 | 4.6 | 4.7 |

### EXAMPLE 2

### Of a Separate Test

For this example, from each of the two gelatin powders a 10% aqueous solution was created, in all cases with distilled water.

In the null sample, only tap water was applied to the wood before applying the wood lacquer.

The created gelatin solutions, analogous to example 1, were applied to an oak wood board (30×11 cm) with a brush, and left to dry for 24 hours at room temperature. Here the total amount applied was always 2 g. After drying, a layer 150 μm thick of white wood lacquer was applied to each pre-treated piece of wood. The boards were stored at 25° C. and 50% relative humidity. Thereafter a measurement of the level of white was performed with a “Minolta CR 200” photometer.

TABLE 2
Results for example 2

| | | Gelatin 1 | Gelatin 2 | Gelatin 3 |
|---|---|---|---|---|
| Meanured values | Null sample | 10% | 10 % | 10% |
| L | 93 | 93.7 | 94.5 | 93.5 |
| b+ | 5.8 | 4.2 | 4.1 | 4.2 |

In this example the product gelatin 2 showed the best results.

Therefore gelatin 2 was chosen for example 3.

### EXAMPLE 3

### Gelatin was Worked into the Wood Handling Material (White Wood Lacquer)

100 g of white wood lacquer were created according to the formula of the Celanese Company and weighed; then a gelatin solution 2 with three different concentrations, 3, 5, and 8%, was added, corresponding in each case to 40% of the solid material ingredient.

The completed samples were stored for 24 hours at room temperature in a closed box. Then they were applied in amounts of 150 and 250 μm coat thickness with a blade onto an untreated oak wood board, and stored for one week at 25° C. and 50% relative humidity.

The measurement of the degree of white was done with the “Minolta CR 200” photometer (previous model of the CR 400).

For comparison, a wood lacquer without gelatin additive was tested at the same time.

TABLE 3
with 150 μm thick coat

| | L | b+ |
|---|---|---|
| Comparison lacquer without additive | 92.6 | 5.4 |
| 3% additive | 93.7 | 4.7 |
| 5% additive | 94.7 | 4.4 |
| 8% additive | 94.6 | 4.5 |

TABLE 4
with 250 μm thick coat

| | L | b+ |
|---|---|---|
| Comparison lacquer without additive | 92.2 | 6.2 |
| 3% additive | 95.2 | 5.5 |
| 5% additive | 95.3 | 5.1 |
| 8% additive | 94.6 | 5.3 |

The sample with 5% gelatin 2 additive showed the best results.

The wood lacquer used in the trials has the general formula given below:

| | |
|---|---|
| Water | 160 g |
| Dispersion materials | 20 g |
| Polishing agent | 50 g |
| Biocide | 4 g |
| Defoamer | 4 g |
| Thickener | 45 g |
| TiO₂ | 460 g (pigment) |
| Solvent | 80 g |
| Binding agent | 1100 g |
| Water | 73 g |

The measurement of the white level was done according to the L*, a* b* in the CIE-1976-color classification system (DIN 6174). According to this the following occurs: the higher the L*value is, the higher is the white level proportion; the higher the b* level is, the higher the yellow color proportion in a sample.

1. A method for preventing the migration of tannin out of wood, comprising:
coating the wood with an aqueous gelatin solution, wherein the concentration of the gelatin solution is 2 to 10%, and the amount applied per cm² of the wood surface is 0.5 to 5 grams.

2. The method according to claim 1, further comprising dissolving powdery gelatin in water to form the aqueous a gelatin solution.

3. The method according to claim 1, further comprising working the aqueous gelatin into a wood treatment material formula.

4. A method for preventing a tannin migration out of wood by coating the wood with a gelatin solution.

5. The method of claim 4, wherein the gelatin solution is contained in a wood treatment materials.

6. The method of claim 1, wherein the concentration of gelatin in the gelatin solution is between 2% to 8%.

7. The method of claim 1, wherein the weight of the gelatin that is applied per cm² of the wood surface is 5 to 10 mg.

8. The method of claim 1, further comprising coating the wood with a wood treatment material after applying the gelatin solution.
